(19) United States
(12) Patent Application Publication
(10) Pub. No.: US 2016/0219870 A1
(43) Pub. Date: Aug. 4, 2016

(54) Stabilization of Blood pH During Sample Storage

(71) Applicant: BECTON, DICKINSON AND COMPANY, Franklin Lakes,, NJ (US)

(72) Inventors: Ling Wang, Cary, NC (US); William Busa, Bahama, NC (US)

(21) Appl. No.: 15/021,104

(22) PCT Filed: Sep. 17, 2013
(86) PCT No.: PCT/US13/60132

§ 371 Date: Mar. 10, 2016

(51) Int. Cl. A01N 1/02

(52) U.S. Cl. CPC A01N 1/0263

(57) ABSTRACT

Disclosed herein is a specimen collection container assembly for stabilizing a pH of a biological specimen including a specimen collection container assembly comprising a carbon dioxide absorbent material disposed in a gas-permeable enclosure in an amount sufficient to absorb carbon dioxide from the biological specimen, thereby stabilizing the pH thereof, and methods of use thereof.

### BACKGROUND

Blood collection and storage using specimen collection containers, such as BD Vacutainer® tubes (Becton, Dickinson and Company, Franklin Lakes, N.J.), have become widely accepted standard practice for conveniently transferring blood samples from a patient to a laboratory for hematology analyses. Specimen collection containers known in the art offer a variety of additives to address various conditions in the blood sample including, but not limited to, coagulation, serum separation, plasma preservation, and glucose determination. Little or no attention, however, has been paid to maintaining the biological healthiness of blood cells in such collection containers for extended periods of time at room temperature.

### SUMMARY

In some aspects, the presently disclosed subject matter provides a specimen collection container assembly for stabilizing a pH of a biological specimen, the specimen collection container assembly comprising a specimen collection container comprising a carbon dioxide absorbent or adsorbent material disposed in a gas-permeable enclosure in an amount sufficient to absorb or adsorb carbon dioxide from the biological specimen, thereby stabilizing the pH thereof.

In other aspects, the presently disclosed subject matter provides a method for stabilizing a pH of a biological specimen stored in a specimen collection container assembly, the method comprising: (a) providing a specimen collection container assembly comprising a specimen collection container comprising a carbon dioxide absorbent or adsorbent material disposed in a gas-permeable enclosure in an amount sufficient to absorb or adsorb carbon dioxide from the biological specimen, thereby stabilizing the pH thereof; and (b) contacting the biological specimen with the gas-permeable enclosure for a period of time, thereby stabilizing the pH of the biological specimen.

Certain aspects of the presently disclosed subject matter having been stated herein above, which are addressed in whole or in part by the presently disclosed subject matter, other aspects will become evident as the description proceeds when taken in connection with the accompanying Examples and Figures as best described herein below.

### BRIEF DESCRIPTION OF THE FIGURES

Having thus described the presently disclosed subject matter in general terms, reference will now be made to the accompanying Figures, which are not necessarily drawn to scale, and wherein:

FIG. 1 shows representative biochemical changes (average±SD, n=3) of venous blood stored at room temperature in BD Vacutainer® tubes in comparison to normal ranges (in shaded areas): (A) glucose concentration (mg/dL), normal range of 70-125 mg/dL; (B) pH, normal range of 7.35-7.45; (C) lactate concentration (mmol/L), normal range <2.5 mmol/L; (D) sodium (Na⁻) concentration mmol/L, normal range of 136-145 mmol/L; (E) potassium (K+) concentration mmol/L, normal range of; and (F) pCO₂;

FIGS. 2A and 2B show (A) increases in cell death (both apoptosis and necrosis) and (B) decreases in cell count of white blood cells during blood storage at room temperature in BD Vacutainer® tubes (average±SD, n=3);

FIG. 3 shows dose-dependent effects of HEPES buffer on stabilizing the pH of blood stored in heparin BD Vacutainer® tubes at room temperature. 45 g/L glucose was supplemented as a carbon source with various concentrations of HEPES buffer or with saline as a control. The HEPES buffer was tested at concentrations compatible with blood osmolality;

FIG. 4 is an illustration of the presently disclosed specimen collection container assembly comprising a carbon dioxide absorbent or adsorbent material; and

FIG. 5 shows the effects of the presently disclosed carbon dioxide absorbent material on pCO₂ and pH of blood stored in a heparin BD Vacutainer® at room temperature. 0.5% starch was injected as a slowly-released carbon source with and without the carbon dioxide absorbent material and saline was injected as a control (average±SD, n=2-3).

### DETAILED DESCRIPTION

The presently disclosed subject matter now will be described more fully hereinafter with reference to the accompanying Figures, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Figures. Therefore, it is to be understood that the presently disclosed subject matter is not to be limited to the specific embodiments disclosed and that modifications and other embodiments are intended to be included within the scope of the appended claims.

### I. Stabilizationof Blood pH During Sample Storage Using a Carbon Dioxide Absorbent or Adsorbent Material

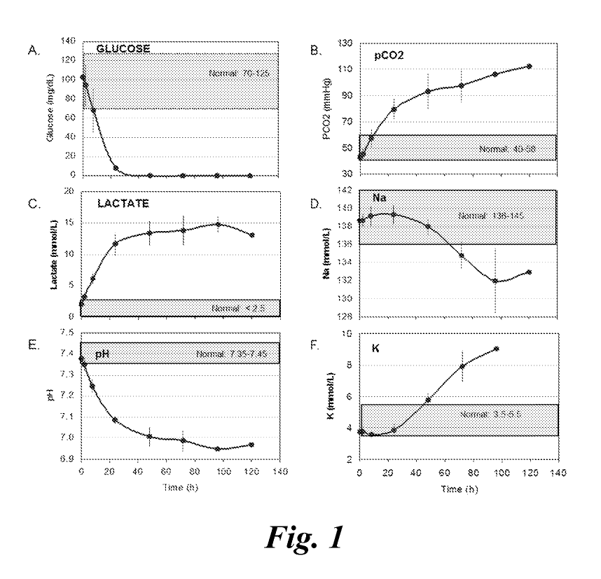

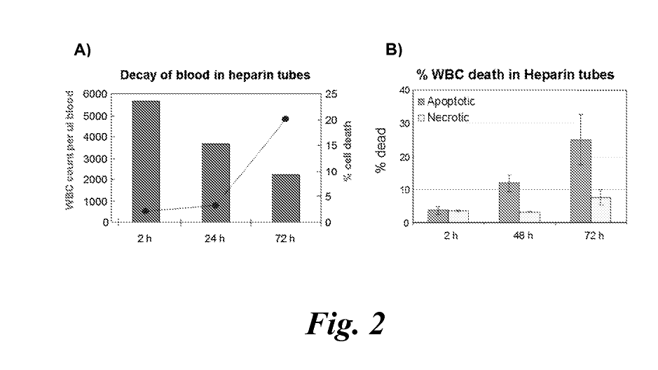

Biochemical characterization of blood cells stored at room temperature in specimen collection containers, e.g., BD Vacutainer® tubes, demonstrates rapid changes in certain physiological parameters of the blood sample, such as glucose concentration, lactate concentration, pH, sodium concentration (Na⁺), potassium concentration (K⁺), and pCO₂ (see FIG. 1). These rapid changes in physiological parameters suggest the formation of a hostile environment surrounding the blood cells over time. This hostile environment was confirmed by a viability assay detecting both apoptosis and necrosis of leukocytes using flow cytometry (see FIG. 2).

Maintenance of physiological pH in a blood sample, however, is one of the most important factors affecting proper functioning of blood cells. The pH of normal, fresh blood is between about 7.35 to about 7.45 and blood cells can comfortably tolerate a shift in pH of about 0.04. Blood cells in a specimen collection container, however, undergo anaerobic metabolism and produce carbon dioxide (CO₂) that results in an increase in the partial pressure of carbon dioxide (pCO₂) and a decrease in pH. This phenomenon is referred to as acidosis. Beaulieu, M., et al., Clinical Biochemistry (1999).

Further, lactate accumulates rapidly with active glycolysis of blood at room temperature, which coincides with the pH drop and serves as an indirect marker of metabolic acidosis. Kemp, G., American Journal of Physiology-Regulatory, Integrative and Comparative Physiology (2004). Because none of the commonly-used anticoagulants, such as ethylenediaminetetraacetic acid (EDTA), heparin, and citrate, has a buffer capacity over the pH range required for maximal survival of stored blood cells, implementation of an adequate buffer system is desirable for long periods of blood storage.

Buffer solutions are used to maintain pH at a nearly constant value in a wide variety of biological applications, such as maintaining a correct pH for enzymes in many organisms to work. Inside a human body, for example, a buffer of carbonic acid (H₂CO₃) and bicarbonate (HCO₃⁻) is the primary mechanism in blood plasma to maintain a pH around 7.4, Robergs, et al., American Journal of Physiology-Regulatory, Integrative and Comparative Physiology (2004), whereas in research, a variety of buffering systems have been applied for maintaining biological samples at physiological pH.

For example, 4-(2-hydroxyethyl)-1-piperazineethanesulfonic acid (HEPES), a zwitterionic organic chemical buffering agent, has been widely used in cell culture and is better at maintaining physiological pH despite changes in CO₂ concentration when compared to bicarbonate buffers. HEPES, however, may produce phototoxicity by the production of hydrogen peroxide when exposed to ambient light. As a result, it is recommended to keep HEPES-containing solutions in darkness as much as possible. Zigler, J., et al., In Vitro Cellular and Developmental Biology-Plant (1985).

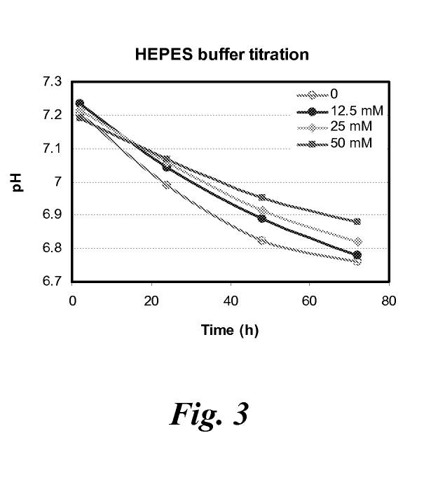

Further, it has been reported that pre-treatment of serum samples with 50 mM or 100 mM of HEPES was able to adjust the pH of blood serum samples to 7.4. Gow, I. F., Analytica Chimica Acta (2001). When the HEPES method was tested in the presently disclosed study with whole blood samples, however, it presented only partial buffering capacity in a dose-dependent manner within the concentration range of 20 mM and hemolysis occurred with blood treated with 50 mM and 100 mM HEPES, most likely due to the osmotic stress of the highly-concentrated buffer solutions (see FIG. 3).

Theoretically, such compromised buffer capacity of HEPES limited by osmolality may be improved by using a polymeric derivative of the buffer, Mulvaney, J. E., et al., Journal of Polymer Science: Polymer Letters Edition (1981); Xin, X., et al., European Polymer Journal (2005), or a polymer that can immobilize the buffer compound, Viegas, et al., U.S. Pat. No. 6,136,334. The synthesis of buffer polymers, however, often is complicated and such systems have not been reported for blood buffering applications. Lowe, A. B. and McCormick, C. L. Chemical Reviews (2002).

### A. Specimen Collection Container Assemblies for Stabilizing pH of a Biological Specimen

To avoid the osmolality issues inherent with buffering solutions, the presently disclosed subject matter is directed toward stabilizing blood pH through the chemical absorption or adsorption of the CO₂ produced by blood cells during storage. As used herein, the term “absorption” refers to a physical or chemical phenomenon or process in which atoms, ions, or molecules enter some bulk phase of a gas, liquid, or solid material. More particularly, “chemical absorption” (also referred to as “reactive absorption”) involves a chemical reaction between a species, i.e., the “absorbate,” e.g., CO₂, and the absorbent material. Chemical absorption depends on the stoichiometry of the reaction and the concentration of the reactants (i.e., absorbate and absorbent). Chemical absorption can be combined with physical absorption.

Accordingly, in some embodiments, the presently disclosed subject matter provides a specimen collection container assembly comprising a CO₂ absorbent material capable of capturing and retaining CO₂ through a chemical reaction, i.e., through chemical absorption. In such embodiments, the process is non-regenerative, e.g., the CO₂ absorbent material is consumed by the process. In some embodiments, the CO₂ absorbent material captures up to about 20% of its own weight in CO₂ (represented as weight/weight (wt/wt)); in some embodiments up to about 30% wt/wt CO₂; and in some embodiments up to about 40% wt/wt CO₂; including up to about 20%, up to about 25%, up to about 30%, up to about 35%, and up to about 40% wt/wt CO₂. In contrast to the osmolality limitations inherent to pH buffering solutions, the presently disclosed specimen collection container assembly can stabilize blood pH through capturing CO₂ produced by blood cells during metabolism in specimen collection containers without affecting the blood composition.

The CO₂ absorbent material can be any material capable of absorbing CO₂ from a biological specimen. Representative CO₂ absorbent materials suitable for use with the presently disclosed subject matter include, but are not limited to, sodium hydroxide, potassium hydroxide, lithium hydroxide, calcium hydroxide, soda lime (e.g., about 75% calcium hydroxide (Ca(OH)₂), about 20% H₂O, about 3% NaOH, and about 1% KOH), magnesium silicate hydroxide, and magnesium iron silicate. In some embodiments, the absorbent material undergoes a color change during the absorption process. Further, the CO₂ absorbent material can have a long shelf life, provided that it is protected from moisture and air.

In particular embodiments, the CO₂ absorbent material comprises sodium hydroxide. Without wishing to be bound to any one particular theory, it is thought that in such embodiments, the sodium hydroxide reacts with CO₂ to form water (H₂O) and sodium carbonate (Na₂CO₃) according to reaction (1):

2NaOH+CO₂→Na₂CO₃+H₂O (1)

In some embodiments, the CO₂ absorbent material comprises sodium hydroxide deposited on an inert carrier, wherein the carrier provides a surface area suitable for providing the rapid, efficient, and quantitative absorption of CO₂. In particular embodiments, the inert carrier comprises silica (SiO₂).

In more particular embodiments, the CO₂ absorbent material comprises Ascarite II® (CAS Number 81133-20-2). Ascarite II® is a specially formulated mixture of sodium hydroxide deposited on an inert silica carrier. Ascarite II® comprises from about 90% to about 95% sodium hydroxide, including about 90%, about 91%, about 92%, about 93%, about 94%, and about 95% sodium hydroxide, and from about 5% to about 10% amorphous, non-fibrous silica, including about 5%, about 6%, about 7%, about 8%, about 9%, and about 10%, amorphous, non-fibrous silica. In Ascarite II®, the sodium hydroxide is coated on the silica. The Ascarite II® can be, in some embodiments, about 8-20 mesh and, in other embodiments, about 20-30 mesh.

In further embodiments, the presently disclosed specimen collection container assembly further comprises a drying agent to absorb the H₂O byproduct generated from the chemical reaction shown in equation (1). In some embodiments, the drying agent comprises calcium sulfate. In particular embodiments, the drying agent is Drierite™, which comprises greater than about 98% calcium sulfate and less than about 2% cobalt chloride.

In other embodiments, the CO₂ can be removed from the specimen by an adsorbent material. As used herein, the term “adsorption” refers to the adhesion of atoms, ions, or molecules from a gas, liquid, or dissolved solid, i.e., an adsorbate, to a surface. Such adhesion creates a film of the adsorbate on the surface of the adsorbent. An “adsorbent” therefore refers to a material having a surface upon which adsorption can occur. Adsorption can occur at an inner or outer surface. Further, the term “desorption” is the reverse of adsorption and, accordingly, also is a surface phenomenon. In such embodiments, the adsorption process is regenerative, i.e., the CO₂ can be removed from the adsorbent material and the adsorbent material can be reused. Activated carbon is a representative adsorbent material capable of adsorbing CO₂ from a biological specimen.

The CO₂ absorbent or adsorbent material, in some embodiments, can be enclosed or sealed in gas-permeable enclosure, which allows the CO₂ absorbent or adsorbent material to absorb and retain CO₂ from the biological specimen without directly contacting the liquid portion of the biological specimen, e.g., blood.

The gas-permeable enclosure can be a barrier, a membrane, a film, tubing, or an inner wall of a specimen collection container. The enclosure can form a part of the specimen collection container or it can be a separate container, which can be placed in the specimen collection container. In some embodiments, the gas-permeable enclosure comprises silicone tubing. In embodiments in which the CO₂ absorbent material comprises sodium hydroxide, the water and sodium carbonate byproducts resulting from the chemical reaction also are generated and contained within the enclosure.

The effectiveness of the CO₂ absorption or adsorption can vary with the length and diameter of the enclosure, the amount of CO₂ absorbent or adsorbent material contained within the enclosure, and the amount of time that the enclosed CO₂ absorbent or adsorbent material is placed in the biological specimen. Defective sealing of the enclosure can cause the CO₂ absorbent or adsorbent material to escape or leak into the specimen sample itself, which could be detrimental to the health of the blood cells upon direct contact.

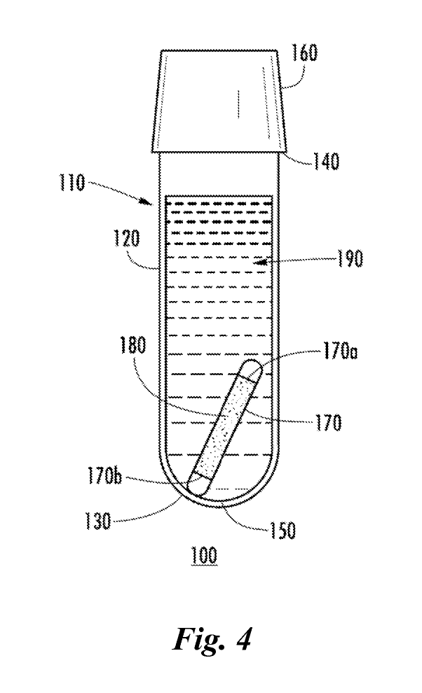

Referring now to FIG. 4, a representative specimen collection container assembly 100 is provided. Specimen collection container assembly 100 includes specimen collection container 110. Specimen collection container 110 can include at least one side wall 120, which is continuous with a bottom wall 130, wherein the at least one side wall 120 defines an open end 140 of specimen collection container 110 and the bottom wall 130 defines a closed end 150 of specimen collection container 110. In some embodiments, open end 140 is covered by a closure 160. In particular embodiments, the at least one side wall 120 comprises a cylinder. In such embodiments, specimen collection container 110 comprises a cylindrical tube.

Referring once again to FIG. 3, specimen collection container assembly 100 includes enclosure 170 comprising a first sealed end 170a and a second sealed end 170b. Enclosure 170 is disposed in specimen collection container 110. Enclosure 170, in some embodiments, can be a tube-shaped enclosure, such as is depicted in FIG. 3. In other embodiments, enclosure 170 can form a part of specimen collection container 110. For example, enclosure 170 can be integrated with the at least one side wall 120 and/or with bottom wall 130.

Enclosure 170 comprises a gas-permeable material. In some embodiments, the gas-permeable material comprises silicone tubing. Further, enclosure 170 contains a CO₂ absorbent or adsorbent material 180 in an amount sufficient to absorb or adsorb CO₂ from the biological specimen. Accordingly, CO₂ present in biological specimen 190 can diffuse through the gas-permeable material of enclosure 170, whereby the CO₂ is absorbed or adsorbed by material 180 and removed from the biological specimen 190. Although enclosure 170 is permeable to the CO₂ present in biological specimen 190, it is impermeable to the liquid portion of the biological specimen 190. As provided in more detail herein below, specimen collection container 110 can include one or more additives.

In some embodiments, the specimen collection container assembly comprises an evacuated specimen collection container assembly, such as a Vacutainer®, or its equivalent. The presently disclosed evacuated specimen collection container assembly can comprise a sterile glass or plastic collection container further comprising a closure adapted such that the tube can be evacuated to create a low pressure, i.e., a vacuum, inside the specimen collection container assembly, which facilitates the draw of a predetermined volume of specimen. Such evacuated specimen collection assemblies commonly are used to draw, for example, a blood sample directly from a subject's vein and also are used to collect urine samples. Representative evacuated specimen collection assemblies are described in U.S. Pat. Nos. 5,344,611; 5,326,535; 5,320,812; 5,257,633; and 5,246,666, each of which is incorporated herein by reference in its entirety.

In some embodiments, the specimen collection container comprises a material selected from the group consisting of a glass or a plastic. In some embodiments, the plastic is selected from the group consisting of polyethylene, polypropylene, polytetrafluoroethylene, polyvinyl chloride, polyethylene terephthalate (PET), polysiloxane, and polystyrene. In particular embodiments, the plastic comprises polyethylene terephthalate (PET). The specimen collection container also can be tinted or colored, e.g., it can have an amber color, for light-sensitive analyte testing.

In some embodiments, the specimen collection container has a length ranging from about 50 mm to about 150 mm and a diameter ranging from about 10 mm to about 20 mm. In further embodiments, the presently disclosed specimen collection assemblies can have a dimension (diameter×length) ranging from about 13 mm×75 mm; 13 mm×100 mm; 16 mm×100 mm; and 16 mm×125 mm. Further, the presently disclosed specimen collection assemblies can have a draw volume ranging from about 1.5 mL to about 10 mL, including about 1.5 mL, about 2.0 mL, about 2.5 mL, about 3.0 mL, about 3.5 mL, about 4.0 mL, about 4.5 mL, about 5.0 mL, about 5.5 mL, about 6.0 mL, about 6.5 mL, about 7.0 mL, about 7.5 mL, about 8.0 mL, about 8.5 mL, about 9.0 mL, about 9.5 mL, and about 10.0 mL. The draw volume of the specimen collection container assembly typically is accurate to about ±10%.

The presently disclosed specimen collection container assemblies, in some embodiments, can contain additives for stabilizing and/or preserving the specimen prior to analytical or diagnostic testing. Representative additives include, but are not limited to, anticoagulants, such as EDTA, including K₂EDTA, sodium citrate (a reversible anticoagulant), oxalate, sodium polyanethol sulfonate (SPS), acid-citrate-dextrose (ACD), or sodium or lithium heparin; a clot activator, such as thrombin (a rapid clot activator); fluoride for preventing glycolysis; an inert gel having an intermediate density between blood cells and serum or blood cells and plasma, which allows for the separation of blood cells from serum or plasma; and combinations thereof.

In some embodiments of the presently disclosed specimen collection container assembly, the gel can form a physical barrier between the serum or plasma and blood cells during centrifugation. In particular embodiments, the gel comprises a polyester-based formulation of inert components. Representative specimen collection assemblies comprising a gel include, but are not limited to, a BD Vacutainer® SST™ Serum Separation Tube or a BD Vacutainer® PST™ Plasma Separation Tube (Becton, Dickinson and Company, Franklin Lakes, N.J.), or their equivalents.

In further embodiments, the specimen collection container assembly comprises two times an amount of gel as is present in a regular specimen collection container assembly. Such embodiments are intended for use primarily when specimens are collected and centrifuged in physician laboratories or other remote collection stations, and then transported back to the laboratory for analysis. Representative specimen collection assemblies comprising two times an amount of gel include, but are not limited to, a BD Vacutainer® SST™ Serum Separation Transport Tube (Becton, Dickinson and Company, Franklin Lakes, N.J.), or its equivalent.

The additive can be added to the specimen collection container assembly either before or after the specimen is collected and, in some embodiments, the additive can be deposited, e.g., spray dried, on an inner surface of the specimen collection container. Further, in some embodiments, the additive that is deposited on an inner surface of the at least one wall and/or the bottom wall comprises a coating for accelerating clotting. In particular embodiments, the coating comprises a material selected from the group consisting of silicone, micronized silica particles, and combinations thereof.

The presently disclosed specimen collection assemblies also include a closure. In some embodiments, the closure comprises a puncturable septum over the open end of the specimen collection container. In other embodiments, the closure comprises a safety-engineered closure. In some embodiments, the safety-engineered closure comprises a Hemogard™ tube closure (Becton, Dickinson and Company, Franklin Lakes, N.J.) or its equivalent. Such closures are recessed within the specimen collection container and are covered by a protective plastic shield to help protect laboratory personnel from contact with blood on the stopper or from around the outer rim of the container. The BD Hemogard™ tube closure also helps prevent blood from splattering when the tube is opened. Similarly, the BD Microgard™ tube closure (Becton, Dickinson and Company, Franklin Lakes, N.J.), or its equivalent, includes a recessed sealing plug and utilizes a “twist assist” technology, which also significantly reduces splatter upon removal.

Further, the presently disclosed specimen collection assemblies can include a variety of labeling options and color-coordinated tops or closures. The meanings of the different colored tops are standardized across manufacturers. For example, a specimen collection container assembly having a gold or Tiger red/black top contains a clot activator and gel for serum separation. Red-topped plastic specimen collection assemblies contain a clot activator and are used when serum is needed. In another example, specimen collection assemblies having a grey/yellow Tiger top contains thrombin, a rapid clot activator for STAT serum testing.

Specimen collection assemblies containing anticoagulants include those with green tops, which contain sodium heparin or lithium heparin for use in plasma determinations in clinical chemistry, e.g., urea and electrolyte determinations; light green or green/gray Tiger tops for plasma determinations; purple or lavender tops containing EDTA (the potassium salt, or K₂EDTA), which is a strong anticoagulant wherein the specimen collection assemblies typically are used for complete blood counts (CBC) and blood films; grey tops, which contain fluoride and oxalate, wherein the fluoride prevents enzymes in the blood from functioning by preventing glycolysis so glucose will not be gradually consumed during storage and wherein the oxalate is an anticoagulant; light blue, which contains a certain amount of citrate, which is a reversible anticoagulant, wherein the specimen collection assemblies typically are used for coagulation assays; dark blue, which contains sodium heparin, an anticoagulant and also can contain EDTA, wherein the tubes are used for trace metal analysis; a pink top, which contains EDTA, and is similar to purple-topped tubes, and are used for blood banking; and black tops, which are used for erythrocyte sedimentation rate.

Other types of evacuated specimen collection assemblies include glass containers having red tops, which contain no additives and are used for tests for antibodies or particular drugs; light yellow tops, which contain sodium polyanethol sulfonate (SPS) and are used for blood culture specimens or acid-citrate-dextrose (ACD), used for blood bank studies, HLA phenotyping, and parental testing; tan (glass or plastic), which contains either sodium heparin (glass) or K₂EDTA (plastic) and are used for lead determinations.

The presently disclosed specimen collection tubes are compatible for use with specimen collection systems known in the art including, but not limited to, BD Vacutainer® Push Button Blood Collection Set (Becton, Dickinson and Company, Franklin Lakes, N.J.), or its equivalent, which is disclosed, in part, in U.S. Pat. Nos. 4,900,307 and 4,747,831, each of which is incorporated herein by reference in its entirety; BD Vacutainer® Safety-Loc™ Blood Collection Set (Becton, Dickinson and Company, Franklin Lakes, N.J.), or its equivalent, for example, which includes a pre-attached holder having a multiple sample luer adapter, tubing, a gripper, and a BD Vacutainer® Safety-Loc™ shield with wings, or its equivalent; BD Vacutainer® passive shielding blood collection needle, or its equivalent; and BD Vacutainer® Eclipse blood collection needle having a pre-attached holder, or its equivalent.

Any specimen collection container assembly known in the art can be adapted for use with the presently disclosed CO₂ absorbent material including, but not limited to, BD Vacutainer® blood collection tubes, such as BD Vacutainer® PST™ Plus plastic tubes, BD Vacutainer® Plus Plastic Serum, BD Vacutainer® SST™ tubes, and BD Vacutainer® K₂EDTA tubes (Becton, Dickinson and Company, Franklin Lakes, N.J.), or their equivalents.

In other embodiments, the presently disclosed specimen collection assemblies can be used to collect urine samples, e.g., adapting collection tubes in the BD Urinalysis Preservative Tube products or the BD Microbiology Collection products (Becton, Dickinson and Company, Franklin Lakes, N.J.), or their equivalents, with the presently disclosed CO₂ absorbent material. The BD Urinalysis Preservative Tube products include a non-mercuric preservative, which ensures specimen quality for up to 72 hours without refrigeration, which is critical to prevent bacterial overgrowth. Such specimen collection tubes can have a minimum and maximum fill line from about 7 mL to about 8 mL to ensure proper additive to urine ratio.

Further, in some embodiments, the presently disclosed specimen collection assemblies, when used with collection containers suitable for use in microbiology applications, further comprise a buffered boric acid formula, e.g., a lyophilized preservative comprising boric acid, sodium formate, and sodium borate, which can maintain the urine integrity for up to 48 hours at room temperature. This lyophilized preservative helps to prevent overgrowth without being toxic to existing pathogens in the sample. Such urine collection tubes typically have a minimum fill line of about 3 mL, which ensures proper additive to urine ratio.

In yet further embodiments, the presently disclosed specimen collection assemblies can include cell preparation tubes comprising sodium citrate or sodium heparin, for the separation of mononuclear cells from whole blood, e.g., a BD Vacutainer® CPT™ specimen collection tube, or a BD Vacutainer® PPT™ Plasma Preparation Tube for molecular diagnostic test methods (Becton, Dickinson and Company, Franklin Lakes, N.J.), or their equivalents.

In yet other embodiments, the presently disclosed specimen collection container assembly comprises a blood collection tube, e.g., BD™ P800 (Becton, Dickinson and Company, Franklin Lakes, N.J.), or its equivalent, for assays that require quantitation and measurement of the Glucagon-Like Peptide 1 (GLP-1), Glucose-Dependent Insulinotropic Polypeptide (GIP), Glucagon, and Ghrelin. For example, such blood collection tubes contain a cocktail of protease, esterase and DPP-IV inhibitors, which provide immediate protection of bioactive peptides from degradation in plasma.

In other embodiments, the presently disclosed specimen collection container assembly comprises stabilizers that immediately solubilize during blood collection and that inhibit the degradation of GLP-1 in plasma, e.g., BD™ P700 tubes (Becton, Dickinson and Company, Franklin Lakes, N.J.), or their equivalent, which results in the protection and preservation of Glucagon-Like Peptide 1 (GLP-1). Such specimen collection containers can comprise a dipeptidyl peptidase IV (DPP-IV) protease inhibitor cocktail and can be used for detecting and quantifying GLP-1 in plasma.

In further embodiments, the presently disclosed specimen collection container assembly comprises stabilizers that immediately solubilize during blood collection and that can protect plasma proteins, e.g., BD™ P100 tubes (Becton, Dickinson and Company, Franklin Lakes, N.J.), or their equivalent, thereby enhancing recovery and preservation of plasma analytes. Such specimen collection containers are compatible with proteomics analysis platforms including, but not limited to, MALDI-TOF, LC-MS, 2D-PAGE, and immunoassays.

In summary, the presently disclosed specimen collection container assembly is highly efficient and reproducible in reducing pCO₂ and stabilizing pH for blood samples stored collection tubes.

Alternatively, the presently disclosed CO₂ absorbent or adsorbent material, and methods of its use, can be applied to any other similar devices where alternative materials or methods may be used as CO₂ absorbents or adsorbents sealed or deposited by any biologically safe, but gas-permeable materials, which form a barrier between the CO₂ absorbent or adsorbent and the biological specimen, e.g., a blood sample. Further, the presently disclosed device also can be applied to other biological sample containers including, but not limited to, blood collection bags where CO₂ accumulation during storage may cause an adverse effect similar to that experienced with blood collection tubes.

In addition to the specimen collection container assembly described hereinabove, the concept of building a barrier between the CO₂ absorbent and the biological sample also can be applied using other approaches, such as spray deposition of microstructures, similar to those described in Choonee, K., et al., Sensors and Actuators A: Physical (2009). For example, in the method disclosed by Choonee et al., polydimethylsiloxane (PDMS) can be spray coated onto a surface, thereby forming a layer of PDMS on the surface. In such embodiments, the PDMS acts as a gas-permeable barrier between the biological specimen and the absorbent or adsorbent material.

### B. Methods for Stabilizing pH of a Biological Specimen

In other embodiments, the presently disclosed subject matter provides a method for stabilizing a pH of a biological specimen stored in a specimen collection container assembly, the method comprising: (a) providing a specimen collection container assembly comprising a specimen collection container comprising a carbon dioxide absorbent or adsorbent material disposed in a gas-permeable enclosure in an amount sufficient to absorb carbon dioxide from the biological specimen, thereby stabilizing the pH thereof; and (b) contacting the biological specimen with the gas-permeable enclosure for a period of time, thereby stabilizing the pH of the biological specimen. In some embodiments, the biological specimen is blood. In other embodiments, the biological specimen is urine.

Although specific terms are employed herein, they are used in a generic and descriptive sense only and not for purposes of limitation. Unless otherwise defined, all technical and scientific terms used herein have the same meaning as commonly understood by one of ordinary skill in the art to which this presently described subject matter belongs.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, parameters, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter. The descriptions and specific examples that follow are only intended for the purposes of illustration, and are not to be construed as limiting in any manner to make compounds of the disclosure by other methods.

### Example 1

### Preparation of Representative Specimen Collection Container Assembly Comprising CO₂ Absorbent Material

Ascarite II® (CAS No. 81133-20-2; Thomas Scientific C049U90) was packed in USP grade unreinforced platinum-cured silicone tubing with a size of 0.078 inch inner diameter×0.141 inch outer diameter×2 inch length (AdvantaPure APST-0078-0141) and the two ends of the tubing were sealed with nontoxic, 100% silicone adhesive sealant (DAP Household Adhesive Sealant). An equivalent empty piece of tubing was likewise sealed. Each of the Ascarite® sealed tubing or the empty sealed tubing (as a control) was placed into a 13-mm×100-mm 6-mL plastic tube having a BD Hemogard™ closure, created vacuum for a 3-mL draw using a lyophilizer to evacuate pressure, and sterilized by gamma radiation (25 kGy).

### Example 2

### Blood Samples

Whole blood samples were drawn from healthy donors into BD Vacutainer® tubes before transferring to Ascarite II® or control tubes using 21 G syringes (BD Medical catalog no. 305784). Samples were stored in a humidity chamber (Associated Environmental Systems no. LH-1.5) at 23° C. for the length of the study until being taken out for assays. Blood biochemistry and gas parameters, including pH, were measured at various time points using an iSTAT Portable Clinical Analyzer (Abaxis catalog no. 600-1009) with CG8+ and CG4+ cartridges (Abbott catalog no. 03M86-01 and 07G02-01) based on the manufacturer's instructions.

### Example 3

### Representative Embodiments

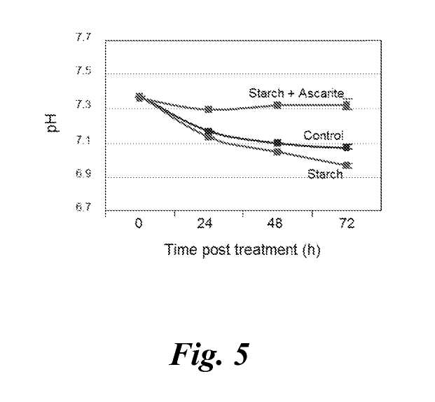

In some embodiments, the presently disclosed specimen collection container assembly comprises gas-permeable silicone tubing containing Ascarite II® (20-30 mesh, sodium hydroxide (NaOH) 90-95% coated non-fibrous silica (SiO₂) 5-10%), which can stabilize the blood pH in blood collection tubes even when starch is supplemented as a carbon source. As shown in FIG. 5, when the presently disclosed specimen collection container assembly comprising Ascarite II® was used, the pCO₂ of a blood sample was reduced, while the decrease in pH was slowed down or even prevented over time.

### REFERENCES

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference. It will be understood that, although a number of patent applications, patents, and other references are referred to herein, such reference does not constitute an admission that any of these documents forms part of the common general knowledge in the art.

Beaulieu, M., Lapointe, Y., and Vinet, B., “Stability of pO₂, pCO₂, and pH in Fresh Blood Samples Stored in a Plastic Syringe with Low Heparin in Relation to Various Blood-Gas and Hematological Parameter,” Clinical Biochemistry, 32(2):101 (1999);

Kemp, G., “Lactate Accumulation, Proton Buffering, and pH Change in Ischemically Exercising Muscle,” American Journal of Physiology-Regulatory, Integrative and Comparative Physiology, 289(3):R895-R901 (2005);

Robergs, R. A., Ghiasvand, F., and Parker, D., “Biochemistry of Exercise-Induced Metabolic Acidosis,” American Journal of Physiology-Regulatory, Integrative and Comparative Physiology, 287(3):R502-R516 (2004);

Zigler, J., et al., “Analysis of the Cytotoxic Effects of Light-Exposed HEPE-Containing Culture Medium,” In Vitro Cellular and Developmental Biology-Plant, 21(5):282 (1985);

Gow, I. F., “Measurement of Ionized Magnesium in HEPES-buffered Serum Samples,” Analytica Chimica Acta, 431(1):143 (2001);

Mulvaney, J. E., Cutler, R. S., and Jensen, R. G., “The Preparation of a Zwitterionic Polymeric Buffer,” Journal of Polymer Science: Polymer Letters Edition, 19(3):103 (1981);

Xin, X., Wang, Y., and Liu, W., “Synthesis of Zwitterionic Block Copolymers via RAFT Polymerization,” European Polymer Journal, 41(7):1539 (2005);

U.S. Pat. No. 6,136,334, for “Medical Uses of In Situ Formed Gels, to Viegas, et al., issued Oct. 24, 2000;

Lowe, A. B. and McCormick, C. L., Synthesis and Solution Properties of Zwitterionic Polymers,” Chemical Reviews, 102(11):4177 (2002);

Choonee, K., et al., “Post Processing of Microstructures by PDMS Spray Deposition,” Sensors and Actuators A: Physical, 155(2):253 (2009); and

U.S. Pat. No. 4,994,378 for Method for Reducing Blood Carbon Dioxide Background in Bacterial Media by the Addition of Micelles of Spooning and a Phospholipid, to Berger, et al., issued Feb. 19, 1991.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A specimen collection container assembly for stabilizing a pH of a biological specimen, the specimen collection container assembly comprising a specimen collection container comprising a carbon dioxide absorbent or adsorbent material disposed in a gas-permeable enclosure in an amount sufficient to absorb carbon dioxide from the biological specimen, thereby stabilizing the pH thereof.

2. The specimen collection container assembly of claim 1, wherein the carbon dioxide absorbent material is selected from the group consisting of sodium hydroxide, potassium hydroxide, lithium hydroxide, calcium hydroxide, soda lime, magnesium silicate hydroxide, and magnesium iron silicate.

3. The specimen collection container assembly of claim 2, wherein the carbon dioxide absorbent material comprises sodium hydroxide.

4. The specimen collection container assembly of claim 3, wherein the sodium hydroxide is deposited onto an inert carrier.

5. The specimen collection container assembly of claim 4, wherein the inert carrier comprises silica.

6. The specimen collection container assembly of claim 1, wherein the carbon dioxide adsorbent material comprises activated carbon.

7. The specimen collection container assembly of claim 1, wherein the gas-permeable enclosure comprises silicone tubing.

8. The specimen collection container assembly of claim 1, wherein the enclosure is sealed.

9. The specimen collection container assembly of claim 8, wherein the enclosure is sealed with a non-toxic sealant.

10. The specimen collection container assembly of claim 9, wherein the non-toxic sealant comprises silicone.

11. The specimen collection container assembly of claim 1, wherein the specimen collection container has at least one side wall continuous with a bottom wall, and wherein the at least one side wall defines an open end and the bottom wall defines a closed end.

12. The specimen collection container assembly of claim 11, wherein the open end of the specimen collection container comprises a closure.

13. The specimen collection container assembly of claim 12, wherein the closure is selected from the group consisting of a puncturable septum and a safety-engineered closure.

14. The specimen collection container assembly of claim 1, wherein the specimen collection container comprises a material selected from the group consisting of a glass or a plastic.

15. The specimen collection container assembly of claim 11, wherein the at least one side wall continuous with a bottom wall forms a cylindrical tube.

16. The specimen collection container assembly of claim 15, wherein the tube has a length ranging from about 50 mm to about 150 mm and a diameter ranging from about 10 mm to about 20 mm.

17. The specimen collection container assembly of claim 1, wherein the specimen collection container is evacuated.

18. The specimen collection container assembly of claim 1, further comprising one or more additives for stabilizing and/or preserving the biological specimen.

19. The specimen collection container assembly of claim 18, wherein the additive is selected from the group consisting of an anticoagulant, a clot activator, a fluoride for preventing glycolysis, and an inert gel.

20. The specimen collection container assembly of claim 19, wherein the anticoagulant is selected from the group consisting of K₂EDTA, sodium citrate, oxalate, sodium polyanethol sulfonate (SPS), acid-citrate-dextrose (ACD), sodium heparin, and lithium heparin.

21. The specimen collection container assembly of claim 19, wherein the clot activator comprises thrombin.

22. The specimen collection container assembly of claim 19, wherein the clot activator is deposited on an inner surface of the specimen collection container.

23. The specimen collection container assembly of claim 22, wherein the clot activator comprises a material selected from the group consisting of silicone, micronized silica particles, and combinations thereof.

24. The specimen collection container assembly of claim 1, wherein the gas-permeable enclosure comprising the carbon dioxide absorbent material further comprises a drying agent.

25. The specimen collection container assembly of claim 24, wherein the drying agent comprises calcium sulfate.

26. The specimen collection container assembly of claim 1, wherein the specimen collection container comprises a specimen collection bag.

27. The specimen collection container assembly of claim 26, wherein the specimen collection bag comprises a polypropylene bag.

28. The specimen collection container assembly of claim 1, wherein the specimen collection container assembly comprises an evacuated specimen collection container.

29. A method for stabilizing a pH of a biological specimen stored in a specimen collection container assembly, the method comprising:
(a) providing a specimen collection container assembly comprising a specimen collection container comprising a carbon dioxide absorbent material disposed in a gas-permeable enclosure in an amount sufficient to absorb carbon dioxide from the biological specimen, thereby stabilizing the pH thereof; and
(b) contacting the biological specimen with the gas-permeable enclosure for a period of time, thereby stabilizing the pH of the biological specimen.

30. The method of claim 29, wherein the biological specimen is blood.

31. The method of claim 29, wherein the biological specimen is urine.
